(19) United States
(12) Patent Application Publication
(10) Pub. No.: US 2013/0024310 A1
(43) Pub. Date: Jan. 24, 2013

(54) Charitable Giving

(71) Applicant: Jord Williams Poster, Boston, MA (US)

(72) Inventor: Jord Williams Poster, Boston, MA (US)

(73) Assignee: CHARITY PARTNERS, INC., Boston, MA (US)

(21) Appl. No.: 13/562,232

(22) Filed: Jul. 30, 2012

Related U.S. Application Data
(63) Continuation of application No. 10/575,570, filed on Apr. 25, 2008, now abandoned.
(60) Provisional application No. 60/590,703, filed on Jul. 23, 2004.

(51) Int. Cl. G06Q 30/06

(52) U.S. Cl. 705/26.1

(57) ABSTRACT

A method for identifying charitable organizations to receive the proceeds generated from the sale of merchandise includes communicating information to purchasers of the merchandise including a price, identities of charities to which donations can be allocated, and a donation amount. An offer to purchase the merchandise and the identities of two or more charities to which the donation is to be allocated is received.

### CROSS REFERENCE TO RELATED APPLICATION

The present application claims the benefit of and priority to U.S. Provisional Application Ser. No. 60/590,703, filed Jul. 23, 2004, the entire disclosure of which is herein incorporated by reference.

### TECHNICAL FIELD

The invention generally relates to raising money for charitable organizations through sales of merchandise and service.

### BACKGROUND INFORMATION

Charitable organizations face a constant challenge of raising sufficient money to fund and support their objectives. One aspect of the challenge is the high overhead costs that are associated with marketing campaigns, solicitation of funds, and the distribution of funds. Many charities still rely on outdated, inefficient methods for contacting potential donors and soliciting donations. Some of these methods, such as telemarketing, direct mail, and door-to-door solicitations require significant administrative and personnel overhead such that only of 40-50% of the funds raised remains for the intended recipients and programs. In addition to using active fundraising methods such as these, charities also must rely on active decisions by consumers to donate to a charity.

Separately, many consumers become somewhat price-insensitive when purchasing certain merchandise, and therefore will pay a premium. This is especially true when there is a limited supply of the merchandise, as well as when proceeds are going to a charity, and even more so when the limited-supply merchandise has a limited time span for which it can be used, such as tickets to sporting or entertainment events. Because tickets to sporting and other events are often sold out, people look to a secondary market (sometimes referred to as ticket brokers) and must pay a significant mark-up or premium to purchase the tickets. As an example, tickets to baseball games at Fenway Park in Boston can be difficult to obtain during the regular season. This situation is magnified, however, during the playoffs, when the majority of tickets are reserved for season ticket holders, Major League Baseball, and the press. It is not unusual for tickets with an original cost (i.e., “face value”) of $100 to command upwards of $500 on the secondary market. Even though sought-after tickets are generally available on the secondary market in limited quantity, many consumers are leery of purchasing tickets through ticket brokers for various reasons.

### SUMMARY OF THE INVENTION

Methods and systems that can fulfill the needs of consumers who are willing to purchase merchandise at a premium while channeling a significant portion of the premium to known charitable entities selected by the consumers can provide peace of mind to the consumers. This is especially true when the merchandise is otherwise difficult or impossible to obtain through typical consumer channels. For example, the demand for tickets to certain events, such as the Super Bowl, the NCAA Final Four, the Academy Awards, concerts, and Broadway shows is often much greater than the supply, and as such these “limited-supply” items are either unobtainable by the general public or sold at a premium through secondary markets. Other purchases that may also generate a premium include once-in-a-lifetime experiences, such as golfing weekends with PGA professionals, race training with NASCAR drivers, or meetings with high profile business and/or political leaders. In addition, “value-add” items such as back stage passes, free parking, or other behind-the-scenes access can be added to generally available items to generate premiums for merchandise that would otherwise be sold at face value. Other merchandise, such as airline and cruise tickets, and other travel packages that are “time limited” (i.e., they expire after some date) and where there is excess supply, may also generate premiums over discounted or wholesale costs. Because the suppliers of these items (airlines, cruise lines, hotel chains) often identify and sell excess inventory to travel wholesalers at significantly reduced prices well in advance, consumers paying a premium may still be able to purchase the merchandise for retail or less than the full retail value, while still generating a premium over the wholesale cost.

In conjunction with purchasing difficult-to-obtain merchandise, consumers can contribute to worthy causes, and therefore simultaneously provide additional sources of revenue for charities. As a result, consumers can convert purchases of premium-generating merchandise into potentially tax-advantaged charitable giving transactions benefiting the consumers, the charities, and the beneficiaries of the charities. For example, an on-line marketplace offering limited-supply, unique, and/or sought-after merchandise at a premium, coupled with a conduit through which the premium can be channeled to charities chosen by the consumer, eases the fundraising and collection challenges faced by charitable organizations, as well as transforms consumers' decisions regarding donating to charities into a passive, efficient, low-overhead process.

In one aspect, the invention relates to a method of identifying charitable organizations to receive proceeds from a sale of merchandise, such as tickets to an event, for example. The method includes communicating information about the merchandise to a purchaser, where the information includes a price, identities of charitable organizations, and a donation amount that will be allocated to the charitable organizations upon purchase of the merchandise. The method also includes receiving, from the purchaser, an offer to purchase the merchandise, and in some cases substantially simultaneously, the identity of a charitable organization to which the donation amount is to be allocated. The donation amount may be allocated to a charitable organization directly or indirectly. The identity of charitable organizations is derived from a database of charitable organizations generated by at least one predetermined variable, including but not limited to the purchaser's location determined by zip code, the purchaser's charitable preferences, venue location, ticket source preference, a third party preference and charitable category. In some embodiments, the purchaser may identify more than one charitable organization to the donation amount is to be allocated.

In some embodiments, the predetermined variables are generated from input given by the purchaser, ticket-source, charitable organization, or any party to a transaction. Such input may be generated through questions or input volunteered by the party. Questions may be directed to a party during a general phase of registration, during a more precise search, or at any time during the searching, selecting, or transacting process. In an embodiment the predetermined variables may generate at least two lists of charitable organizations. The lists may be grouped according to specific criteria, such as but not limited to, local charities, national charities, cancer-related charities, art-associated charities, etc.

The donation amount can be expressed as a percentage of the price (such as 25%, 50%, 100%, etc.) or in some cases a fixed dollar amount. The merchandise can be obtained from a seller at a cost, or for free (i.e., at a cost of zero). In cases where the merchandise is obtained from a seller at a cost, the donation can be the difference between the price and the cost, or in some cases the difference between the price and the cost plus one or more fees, such as a delivery fee, a ticket source fee, a processing fee, and an administrative fee. In other embodiments, the list price may include a donation, or the donation amount may be listed separately. In other embodiments, the identities of the charitable organizations can be provided by the seller of the merchandise.

In some embodiments, the charitable organizations are qualified as such (for example, by determining that the organization is recognized as a charity by the IRS) prior to their identities being sent to the purchaser.

The merchandise may be shipped to the purchaser, or in some cases picked up at a predetermined location (e.g., a box office available), or made available for e-ticketing. Payment for the merchandise can be received from the purchaser, and the donation amount can be forwarded to the identified charitable organizations, which may be done so in equal shares, or in some cases based on a percentage allocation which may be provided by the purchaser, seller, provider, or some other variable. The charitable organizations can be notified of the donation, using, for example, email, and can include the price of the merchandise purchased, the donation amount, information identifying the purchaser, and a description of the merchandise.

In some embodiments, the charitable organization, or organizations are not included in the identities of charitable organizations provided to the purchaser, and in some cases those organizations not included in the identities of charitable organizations provided to the purchaser can be qualified as charitable organizations. A confirmation including at least one of the price, a description of the merchandise, the donation amount, a customizable acknowledgment from said charitable organization, other fees and the charities can be transmitted (via email, for example) to the purchaser.

In another aspect, a method of allocating proceeds from a sale of merchandise (such as tickets or ticket packages to an event) to charitable organizations includes communicating information about the merchandise to consumers and receiving offers from one or more of the consumers, including an offer price to purchase the merchandise. The method also includes selecting one of the offers as a winning offer, designating the consumer who submitted the winning offer as a purchaser of the merchandise, and communicating an indication to the purchaser that their offer was accepted, and the identities of charitable organizations. The method further includes receiving from the purchaser the identity of a charitable organization to which a portion of the winning offer price is to be allocated, and allocating a portion of the wining offer price to the charitable organization. The identity of the charitable organization is derived from a database of charitable organizations generated by predetermined variables, including but not limited to the purchaser's location determined by zip code, the purchaser's charitable preferences, venue location, ticket source preference, and charitable category. In some embodiments, the purchaser may identify more than one charitable organization to which the donation amount is to be allocated.

The information can include a percentage of the sale proceeds that will be donated to charitable organizations such as 25%, 50%, 100%, etc., or in some cases a fixed dollar amount that will be donated to charitable organizations. In some embodiments, the merchandise is obtained from a seller at a cost, which in some cases may be zero. In cases where the merchandise is obtained from a seller at a cost, the portion of the offer price allocated to the charitable organization can be the difference between the winning offer price and the cost, or in some cases the difference between the winning offer price and the cost plus one or more fees, such as a delivery fee, a processing fee (such as those fees charged by credit card companies, for example), and an administrative fee. In other embodiments, the identities of the charitable organizations can be provided by the seller of the merchandise.

In some embodiments, the charitable organizations are qualified as such (for example, by determining that the organization is recognized as a charity by the IRS) prior to their identities being sent to the purchaser. Charitable organizations may be further qualified in order to be considered. Some criteria for qualifying organizations includes, but is not limited to, a required length of time of operation (such as, e.g., 5 years), non-denominational organization, non-politically affiliated, and efficiency criteria requiring a minimum percentage of funds to go to non-program costs. It is further contemplated that minimum standards are required to maintain status on the platform, such as but not limited to, a minimum percent of funds allocated to program costs. The merchandise may be shipped to the purchaser. Payment for the merchandise can be received from the purchaser, and the portion of the winning price can be forwarded to the two or more identified charitable organizations, which may be in equal shares, or in some cases based on a percentage allocation provided by the purchaser. The charitable organizations can be notified (via email, for example) of the portion of the wining price allocated to them and the notification can include the winning price, the portion of the winning price allocated to each of the charitable organizations, information identifying the purchaser, and a description of the merchandise.

In some embodiments, the identified charitable organizations are not included in the identities of charitable organizations provided to the purchaser, and in some cases those organizations not included in the identities of charitable organizations provided to the purchaser can be qualified as charitable organizations. A confirmation can be transmitted to the purchaser (e.g., via email) including the winning offer price, a description of the merchandise, the portions of the winning price allocated to the identified charitable organizations, and the identities of the two or more identified charitable organizations.

In another aspect, a computerized method of allocating proceeds from an online sale of merchandise to charitable organizations includes posting information about the merchandise including a price and a donation amount to be allocated to charitable organizations upon the purchase of the merchandise on a web page and receiving a first electronic notification from a purchaser of the merchandise including an offer to purchase the merchandise for the posted price plus the donation amount. The method further includes electronically communicating an acceptance of the offer to the purchaser including the identity of a charitable organization to which the donation amount may be allocated. The method also includes receiving from the purchaser and in response to the acceptance, a second electronic notification including the identity of a charitable organization to which the donation amount is to be allocated, and allocating the donation amount according to the second received notification. The identity of charitable organizations is derived from a database of charitable organizations generated by predetermined variables, including but not limited to the purchaser's location determined by zip code, the purchaser's charitable preferences, venue location, ticket source preference, third party preference and charitable category. In some embodiments, the purchaser may identify more than one charitable organization to the donation amount is to be allocated.

In another aspect, the invention relates to a method of allocating charitable donations to charities and includes receiving information about merchandise (such as tickets to an event, for example) from a seller of the merchandise including a price, a donation amount to be allocated to charitable organizations, and the identities of charitable organizations to which the donation amount can be allocated. The method also includes submitting an offer to purchase the merchandise, and submitting, in some embodiments substantially simultaneously, the identity of a charitable organization to which the donation is to be allocated. The identity of charitable organizations is derived from a database of charitable organizations generated by predetermined variables, including but not limited to the purchaser's location determined by zip code, the purchaser's charitable preferences, venue location, ticket source preference, third party preference and charitable category. In some embodiments, the purchaser may identify more than one charitable organization to the donation amount is to be allocated.

The donation amount can be expressed as a percentage of the price (such as 25%, 50%, 100%, etc.) or in some cases a fixed dollar amount. Payment information can be sent to the seller of the merchandise, and the merchandise can be received from the seller. The identities of the two or more charitable organizations can also include a percentage allocation indicating a preferred allocation of the donation amount among the two or more identified charitable organizations.

In some embodiments, the identified charitable organizations include one or more organizations that are not included in the received identities of charitable organizations. A confirmation of acceptance of the offer can be received, via email for example, and can include the price, a description of the merchandise, the donation amount, and the identities of the two or more identified charitable organizations.

Another aspect of the invention provides a system for allocating charitable donations to charitable organizations and includes a merchandise database for storing information including a price and a donation amount associated with merchandise to be sold and a charity database for storing information associated with charitable organizations. The system also includes a first communications module for sending information associated with the merchandise to be sold and information associated with the charitable organizations to a purchaser of the merchandise. The system further includes a second communications module for receiving, from the purchaser, an offer to purchase the merchandise and identities of a charitable organization to which the donation amount is to be allocated. The identity of charitable organizations is derived from a database of charitable organizations generated by predetermined variables, including but not limited to the purchaser's location determined by zip code, the purchaser's charitable preferences, venue location, ticket source preference, third party preference and charitable category. In some embodiments, the purchaser may identify more than one charitable organization to the donation amount is to be allocated.

In some embodiments, the system also includes a commerce module for receiving and processing payment instructions from the purchaser of the merchandise. An allocation module can allocate the donation amount among the one or more identified charitable organizations, and in some embodiments affects payments to the one or more identified charitable organizations, information about which can be stored in a payment database. In some embodiments, a reporting module generates reports describing the data in the merchandise database, the charity database, and the payment database. The system can also include a fee-processing module for determining one or more fees associated with the offer to purchase the merchandise.

The second communication module can transmit, via email for example, a confirmation to the purchaser confirming an acceptance of the offer to purchase the merchandise, which can include the price, the donation amount, and the identities of the one or more charitable organizations to which the donation amount is to be allocated.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is an illustration of an environment in which an embodiment of the invention can operate.

FIG. 2 is a block diagram illustrating one embodiment of the invention.

FIG. 3 is a block diagram of one embodiment of a server in the system of FIG. 2.

FIG. 4 is a flow diagram of one possible embodiment of a system according to the invention.

FIG. 5 is a flow diagram of one possible embodiment of a system according to the invention.

FIG. 6 is a screen display of a merchandise search screen in an embodiment of the invention.

FIG. 7 is a screen display of search results screen in an embodiment of the invention.

FIG. 8 is an illustration of the pricing and fee structure in an embodiment of the invention.

FIG. 9 is a screen display of a donation allocation screen in an embodiment of the invention.

FIG. 10 is a screen display of a confirmation screen in an embodiment of the invention.

FIG. 11 is a sample donation confirmation letter in an embodiment of the invention.

### DESCRIPTION

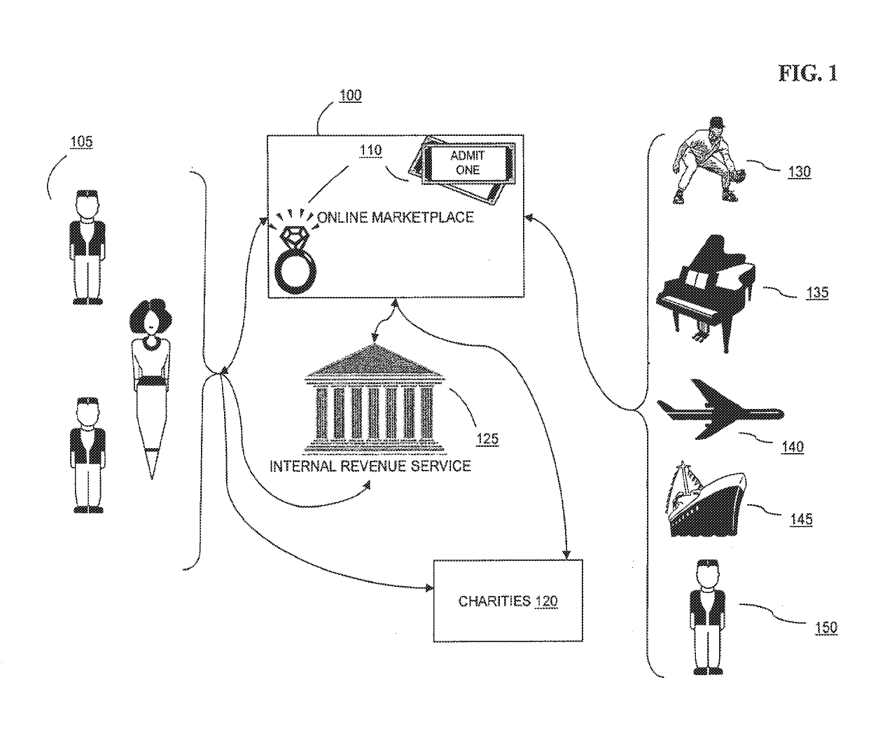

Referring to FIG. 1, in one embodiment, an on-line marketplace 100 provides consumers 105 with the opportunity to purchase merchandise 110. In some instances, the merchandise offered in the on-line marketplace 100 is of a limited-supply nature, i.e. the demand for such items exceeds the supply. Non-limiting examples of limited-supply merchandise can include tickets to sporting events, concerts, theatre, and other high-demand and/or infrequent performances as well as unique items such as designer jewelry, limited edition artwork, newly released toys, or other collectibles where the demand for the items is greater than the supply. The merchandise can, in some embodiments, be generally available, but packaged with free parking, back-stage passes, or other value-added items or experiences not usually included with the generally available merchandise that can generate additional revenue. Because the supply of the merchandise does not fulfill the demand, consumers 105 are willing to pay a “premium”—(i.e., more than the face value) for the merchandise. For example, tickets to high-demand sporting events such as the World Series, the Super Bowl, or the NCAA “Final Four” basketball tournament often generate premiums that can range upwards of ten to twenty times the face value of the ticket. However, consumers 105 wishing to purchase event tickets 110 have few choices when looking to purchase such tickets 110 and often must deal with ticket brokers to do so. In addition to the high costs of the tickets 110, the gray-market nature of the ticket brokers and others selling similar merchandise 110 can cause many consumers 105 to eschew purchasing merchandise 110 through these avenues. Many of the organizers and promoters of these events also frown on such activities. In addition, once-in-a-lifetime experiences such as golf weekends with PGA professionals, coach for a day, cast parties, passes to on-location movie shoots, and travel opportunities (airline tickets, cruise tickets, etc.) as well as other experiential merchandise can be packaged and sold using the systems and methods described herein. Whereas limited-supply items such as those described above may be available though alternative means, life experience packages that may involve meeting celebrities, access to private property, or other unique events may be otherwise unavailable to the consumer.

Because event tickets are in high demand and difficult to obtain, counterfeit tickets are widely circulated, and present a major concern for purchasers. The widespread availability of counterfeit tickets may prevent purchase transactions, as purchasers cannot rely on the authenticity of an event ticket through secondary market sources. In some embodiments of the present invention, a method of authenticating the tickets to be sold is provided. Methods of authenticating tickets are known in the art, and include appending a unique code to every ticket printed in a copy-safe ink that will not duplicate. The customer can go to a website and enter the code to authenticate against a database of associated valid identifiers. Another embodiment provides that consumers can scan the barcode and transmit the information to a central database to verify the authenticity. Still a further embodiment provides that tickets offered by sale from consumers or third-parties must be registered. The ticket is registered by scanning the barcode or entering the associated series of numbers which will be verified against a central database of valid sequenced tickets. Tickets can only be registered once all subsequent attempts to register the same ticket will be rejected for resale on our platform.

As other non-limiting examples of merchandise that can generate premiums, travel items such as airline tickets, cruises, hotel rooms, and other time-limited merchandise can be sold using the systems and methods described herein. For example, many airline, cruise line, and hotel chains can predict excess capacity on certain air routes and cruises, of particular rooms at certain times of the year or week, or even complete travel packages, sometimes well in advance. However, public access to these tickets or packages can be limited, as the inventory is often bundled into large blocks and sold to travel agencies, vacation outlets, and other similar establishments. Because the administrator of the marketplace 100 may have access to these items at reduced rates, they can be sold to consumers at a premium, while still being below the retail costs a consumer would normally pay for an item.

Again referring to FIG. 1, the on-line marketplace 100 also facilitates the participation of charitable organizations 120. These organizations 120 can be, for example, national charities such as the Red Cross and the United Way, charities that provide funds for medical research, local charities such as a neighborhood after-school program or camp, or charities benefiting a particular person or family that needs assistance. In some embodiments, participation by the charities 120 in the marketplace 100 may depend on whether the charity 120 has been identified as a charitable organization by the Internal Revenue Service 125 according to Section 501(c) of the tax code. In other embodiments, the charities 120 may not be recognized as charitable organizations by the IRS, but may achieve such designation prior to receiving donations through the marketplace 100. By being designated as such, consumers 105 who donate to the charities 120 may be eligible to receive tax deductions based on their donations. In other cases, charitable organizations 120 may participate in the marketplace 100 without such designation, however consumers 105 donating to such charities may not receive favorable tax treatment for their donations.

Additional participants in the on-line marketplace 100 may also include, for example, owners of sports teams 130, concert promoters 135, airlines 140, cruise lines 145 (or other companies providing travel related services) or other individuals 150 who have access to limited-supply merchandise 110. Team owners 130 may participate in the marketplace by donating, or selling at cost or at a reduced cost, tickets 110 to high demand games to the marketplace 100. The tickets 110 may be provided on an ongoing basis, or in some cases for single games or events. Other participants that may provide inventory 110 for the marketplace 100 include collectors of highly-sought after merchandise, concert promoters 135, or individuals 140 that have access to such merchandise, such as season ticket holders, league officials, and celebrities.

Once the marketplace 100 has an inventory of merchandise 100, consumers 105 can directly purchase, or in some cases bid on at auction, the merchandise 110. Due to the limited-supply nature of the merchandise 110, often these purchases will be at a premium. However, unlike ticket brokers who keep the premiums generated by their sales, the premium (or a portion thereof) generated by sales in the marketplace 100 can be allocated to one, or in some cases two or more of the charities 120. By indicating to the consumer 105 during the purchase process that premiums can be allocated to one or more charitable organizations 120, the stigma associated with paying the premium for merchandise 110 such as tickets to concerts and sporting events is lessened, and consumers 105 are more likely to be willing to pay such premiums. By marrying the consumers' desire to obtain limited-supply merchandise 110 and providing a means by which the consumer 105 can simultaneously donate a portion of the purchase price to a charity 120, the marketplace 100 generates additional income for the charities 120 by directing funds away from gray-market brokers and unknown merchants and into the coffers of well-deserved charities 120.

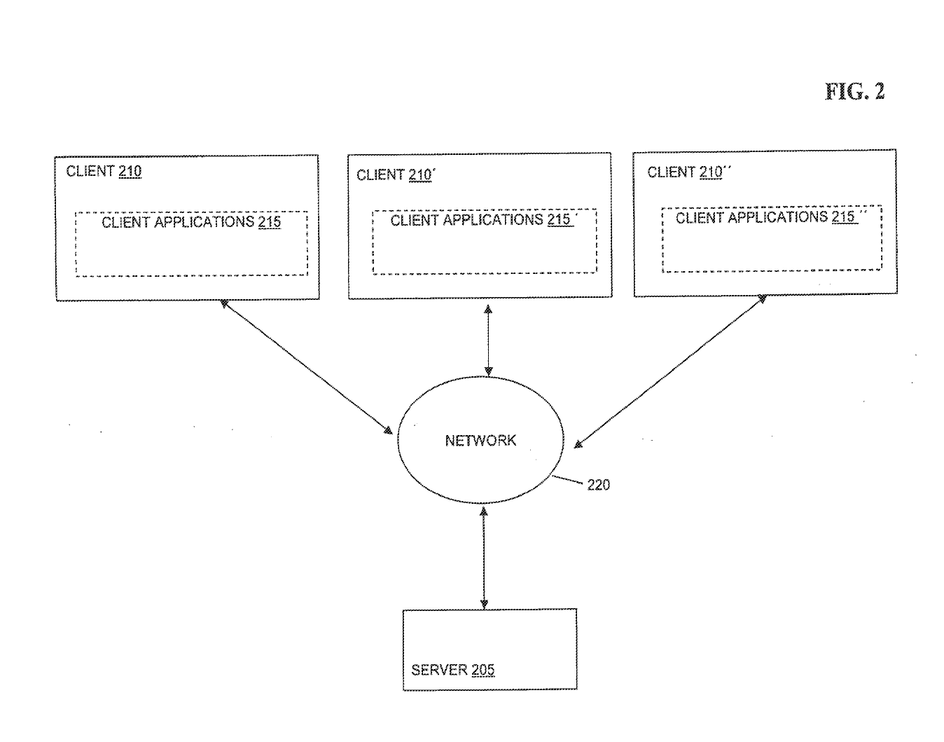

Referring to FIG. 2, in one embodiment, the methods described above may be implemented using an on-line marketplace system 200 including at least one server 205, and at least one client 210, 210′, and 210″, generally 210. As shown, the system 200 includes three clients 210, 210′, 210″, but this is only for exemplary purposes, and it is intended that there can be any number of clients 210. The client 210 is preferably implemented as software running on a personal computer (e.g., a PC with an INTEL processor or an APPLE MACINTOSH) capable of running such operating systems as the MICROSOFT WINDOWS family of operating systems from Microsoft Corporation of Redmond, Wash., the MACINTOSH operating system from Apple Computer of Cupertino, Calif., and various varieties of Unix, such as SUN SOLARIS from SUN MICROSYSTEMS, and GNU/Linux from RED HAT, INC. of Durham, N.C. (and others). The client 210 could also be implemented on such hardware as a smart or dumb terminal, network computer, personal data assistant, cellular telephone, wireless device, information appliance, workstation, minicomputer, mainframe computer, kiosk, or other computing device, that is operated as a general purpose computer or a special purpose hardware device used for serving as a client 210 in the on-line marketplace 200.

Consumers 105 use the clients 210 to search for and purchase merchandise 110 in the on-line marketplace 100. In some embodiments, charities 120 can also operate the clients 210 to enroll in the marketplace 100, view merchandise 110 being sold to benefit the charity 120, receive notifications regarding pending donations, or other activities associated with receiving donations from consumers 105. In various embodiments, the client computer 210 includes client applications 215. One example of a client application 215 is a web browser application that allows the client 210 to request a web page (e.g., from the server 205) with an HTTP web page request. An example of a web page is a data file that includes computer executable or interpretable information, input forms, graphics, sound, text, and/or video, that can be displayed, executed, posted, played, processed, streamed, and/or stored and that can contain links, or pointers, to other web pages. In one embodiment, a user of the client 210 such as a consumer 105 looking to purchase merchandise 110 from the marketplace 100 manually requests a web page from the server 205. Alternatively, the client 210 automatically makes requests with the web browser. Examples of commercially available web browser software are INTERNET EXPLORER, offered by Microsoft Corporation of Redmond, Wash., and NETSCAPE NAVIGATOR, offered by AOL/Time Warner of Mountain View, Calif.

A communications network 220 connects the client 210 with the server 205. The communication may take place via any media such as standard telephone lines, LAN or WAN links (e.g., T1, T3, 56kb, X.25), broadband connections (ISDN, Frame Relay, ATM), wireless links, and so on. Preferably, the network 220 can carry TCP/IP protocol communications, and HTTP/HTTPS requests made by the web browser and the connection between the client applications 215 and the server 205 can be communicated over such TCP/IP networks. The type of network is not a limitation, however, and any suitable network may be used. Typical examples of networks that can serve as the communications network 220 include a wireless or wired ethernet-based intranet, a local or wide-area network (LAN or WAN), and/or the global communications network known as the Internet, which may accommodate many different communications media and protocols.

In some embodiments, an employee of the marketplace 100 operates a central server 205, which interacts with clients 210. In some embodiments, one or more third parties may manage the server 205, which may include providing the hardware, software, communications, and services to the server 205. The server 205 is preferably implemented on one or more server class computers that have sufficient memory, data storage, and processing power and that run a server class operating system (e.g. SUN Solaris, GNU/Linux, MICROSOFT WINDOWS 2000, MICROSOFT SERVER 2003, or other such operating system). Other types of system hardware and software than that described here could also be used, depending on the capacity of the device and the number of users and the amount of data received. For example, the server 205 may be part of a server farm or server network, which is a logical group of one or more servers. As another example, there could be multiple servers 205 that may be associated or connected with each other, or multiple servers could operate independently, but with shared data. As is typical in large-scale systems, application software could be implemented in components, with different components running on different server computers, on the same server, or some combination.

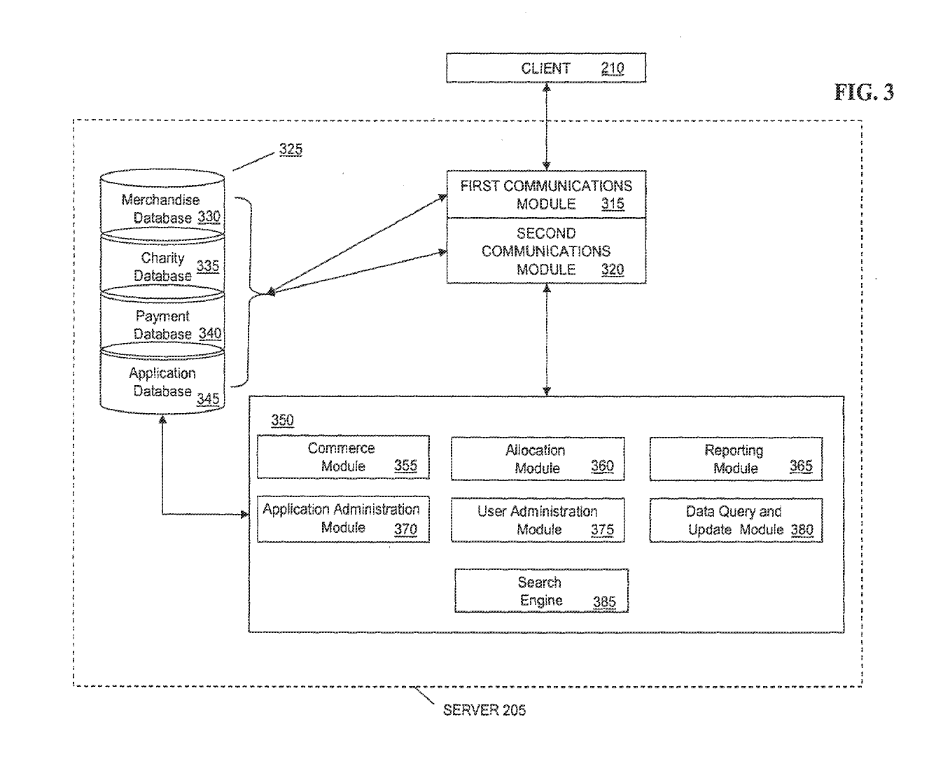

Referring to FIG. 3, in one embodiment, the server 205 includes a first communications module 315, such as a web server, that serves as the communication interface with clients 210 involving the transfer of files and data. In some embodiments, the first communications module 315 is the interface for communication with clients 210 involving HTTP/S requests and responses, Java messages, SMTP messages, POP3 messages, web services using, for example, SOAP/XML, instant messages, as well as other electronic messages. In some instances, messages may be transferred from the client 210 to the server 205, from the server 205 to the client 210, or both. The first communications module 315 can be implemented as software running on one or more servers, or may be implemented as a stand-alone server. The first communications module 315 can also provide the conduit through which the server 205 communicates with other applications, servers, web services, and devices for the purpose of data transmission, data sharing, and data replication.

The server 205 also includes a second communications module 320, such as a web server, that also communicates with the clients 210. In some instances the first and second communications servers are implemented as one software module performing distinct tasks, and in other embodiments the tasks may be allocated at random during runtime. In some cases, the two communications modules may in fact be the same module, and facilitating the allocation of functions to different processors based on availability, usage, task type, or other methods. By allocating communications across one or more servers, processors, or software modules, the server 205 is able to provide redundancy and perform tasks such as load-balancing, disaster recovery, and failover.

The communication modules 315 and 320 communicate with a database module 325 and an application server 350, which provide the data storage and main programming logic for the operation of the system 200. In one embodiment, the application server 350 is implemented as one or more application programs (e.g., Internet Information Server from Microsoft Corporation, WebSphere from International Business Machines Corporation, or other such application) running on a server class computer, which may be the same or different computer as the communication modules 315, 320. The application server 350 processes search requests for merchandise, requests and retrieves information from one or more databases on the database module 325, constructs HTML forms consisting of merchandise information, transmits the forms to consumers 105 via the client 210, and receives data from the consumers 105 via the communication servers 315 and 320 on forms completed on the client 210.

In one embodiment, the application server 350 includes a commerce module 355, an allocation module 360, a reporting module 365, an application administration module 370, a user administration module 375, a data query and update module 380, and a search engine 385.

The commerce module 355 facilitates the selling, auctioning, and purchasing activities of the marketplace 100. For example, where the purchase process is “first-come-first-serve” (i.e., not an auction sale) the commerce module 355 determines the price at which an item is to be sold, including any premiums, processing fees, delivery fees and donations. The commerce module 355 also collects payment information from consumers 105 such as credit card information, account information relating to the Paypal on-line payment and electronic funds transfer service at www.paypal.com, or other payment data and in some cases communicates with external payment validation vendors (e.g., Verisign, American Express, etc) via the communication modules 315 and 320 to determine the validity of the information. Upon receiving validation of payment terms the commerce module 355 can also send payment instructions to banks for settlement and delivery of fees. In some embodiments where the merchandise is being sold to or from foreign countries, the commerce module 355 may translate foreign currency amounts into US dollars, or vice versa. The commerce module 355, where necessary, may also calculate sales tax, or other taxes required by federal, state, or local laws, and incorporate the taxes into the purchase price.

Where the merchandise is being sold using an auction model (e.g., time limited sale with the item or items being awarded to the highest-bidder), the commerce module 355 also records and ranks incoming offers from multiple consumers 105, validates new offers based on criteria such as minimum bids and/or minimum increments and keeps track of the time remaining in the auction. Once the auction has expired, the commerce module 355 identifies the winning bid, identifies the consumer 105 that submitted the winning bid, and performs similar functions as described above to effectuate payment, calculate fees, taxes, donations, etc. Data collected by the commerce module 355 can then be stored in the database module 325 for billing, record-keeping, or other auditing purposes.

The allocation module 360 determines the identity(s) of the charitable organization or organizations 120 that will receive a donation based on the premium paid by the consumer 105, the allocation of the premium among the identified charities 120, and effectuates payment to the charities 120 on behalf of the consumer 105 that purchased the merchandise 110. For example, in one instance the marketplace 100 may have available a set of four tickets to a World Series game for $1000, and indicate that because the tickets were purchased by the marketplace 100 for $400, a premium of $600 is available as a donation amount. A consumer 105, having offered to purchase the tickets 110 for $1000, also indicates that they would like $200 to be donated to the Red Cross, $100 to be donated to their son's Boy Scout troupe, and $300 to be donated to their church. Alternatively, if the tickets 110 were being offered at auction where the ultimate purchase price is unknown until the end of the auction, the consumer 105 may provide such information as a percentage allocation, i.e. 50% of the premium to charity A, and 25% to each of charities B and C. In some cases, additional fees such as delivery fees, processing fees, taxes, or other administrative fees may be assessed to cover postage, overhead, etc. In such cases, the allocation module 360 uses the information provided by the consumer 105 in conjunction with the fees to determine an actual donation amount to be sent to each of the indicated charitable organizations 120. Actual payments allocated to charities 120 are subsequently stored in the database module 325.

The application server 350 also includes a reporting module 365 that compiles data, text, graphics and other information from the application server 450 and database module 325. The compile data allows administrators of the marketplace 100, consumers 105, charities 120 and other users of the marketplace 100 to request, generate, view, print and deliver reports. For example, the reporting module 365 compiles information from the database module 325 regarding the inventory of merchandise available for sale, past purchases by individual consumer 105, consumer demographics, and merchandise type, charities authorized to receive donations, and past donations. In one embodiment, the report can generated in HTML, sent from the server 205 to the client 210 over the communications network 220, and viewed on a client application 215, printed, or saved locally to the client 210.

The application server also includes an application administration module 370 that stores instructions and templates for compiling HTML pages to be viewed by the consumers 105. The data included on the HTML pages can include information retrieved from the database module 325, static HTML files stored on the server 205, dynamically generated HTML files (using, for example, Active Server Pages, javascript, or other like technology), flash pages such as those developed using Marcomedia Flash from Macromedia of San Francisco, Calif., image files such as bitmaps and jpeg files stored on the server or an alternative external storage device, and other browser-executable code. The compiled HTML pages are then provided to the consumers 105 via the communications modules 315 and 320, the network 220, and the clients 210. In some instances, the HTML pages provided to the consumers 105 include forms for collecting and in some cases verifying information provided by the consumers 105, charities 120, and other users of the marketplace. In such cases, the application administration module 370 constructs forms for requesting and receiving registration information, search criteria and other user specified. In cases where data validation is warranted, the data can be validated against data in the database module 325, previously provided data, independently verifiable information such as an email address, or known listings such as state names.

In some embodiments, the application administration module 370 combines HTML pages containing merchandise and charity information with advertisements. Such advertisements may be targeted based on the content of the ads and the merchandise being presented on the page, or in some cases randomly selected. For example, if the merchandise being presented is tickets to a sporting event, the advertisements may be for sports apparel including a team logo, sporting equipment, or travel offers to the city where the event is taking place. In some embodiments where the application is hosted and operated by a third party, the third party may determine the advertisements that are presented to the consumer.

The user administration module 375 provides user-level security, access rights, and verification services for the application server 350. For example, a consumer 105 wishing to register to use the marketplace 100 may be asked to provide a user name, a password, an email address, and other personal information to verify their identity and assure uniqueness of identifying names. In some embodiments, the username may be the users' email address, whereas in other embodiments the username may be generated by the user administration module 375. The user administration module 375 can also assign user types or “roles” to individual users to determine the security, data access, and operational functions available to users. The administration module 375 identifies the user as a consumer by, for example, indicating that particular user has a user type of “consumer” associated with her. Similarly, a charity may register as a participant in the marketplace 100, and be assigned a user type of “charity.” Upon returning to the marketplace, the consumer is limited to those application functions identified as consumer functions, and similarly a user logging in using an ID associated with a charity may have access to a different subset of application functions. For example, a consumer 105 user may be able to search merchandise available for purchase, review information about charities, and participate in auctions, whereas a user identified as a charity may be able to search merchandise for sale, but not participate in auctions. In some embodiments, charities may be able to log in and use the reporting module to view pending payments based on sales, and lists of donors.

The data query and update module 380 provides an interface from the application server 350 to the database module 325. For example, the administration module 370, reporting module 365, or other modules of the application server 350 require the retrieval, inserting, updating, or deleting of data from the database 325, the data query and update module 380 receives the database instructions (such as SQL calls) and forwards them to the database module 325.

The search engine 385 facilitates the keyword, string, and other searching and ranking of information stored in the database module 325. In some embodiments the administrators of the marketplace 100 may allow consumers to search through the available merchandise to find particular items, or, in some cases, confirm that the charities they are interested in donating to are marketplace participants. The search engine 385 indexes some or all of the data in the database 325 on a periodic basis, and stores one or more index files on the server 205. One index file may be a merchandise index, whereas another index file may list the charities 120. A user interested in purchasing tickets for the Super Bowl may enter the term “Super Bowl” as a search string on a web page that invokes the search engine, submit the query to the search engine 385. The search engine 385 then scans the merchandise index file for the term “Super Bowl,” and returns, on an HTML page, for example, a listing of all the merchandise with the string “Super Bowl” in its description. Subsequently, the consumer 105 may wish to search for a charity to which they are interested in making a donation were they to purchase the tickets. Entering “Red Cross” in the search engine page would return a listing of charities with that phrase. In some embodiments, the consumer may enter compound searches, such as Red Sox, July, Jimmy Fund, and under $200 to find, for example, tickets to a Boston Red Sox game in July for under $200, where the premium can be directed to the Jimmy Fund Cancer Research Charity (see http://www.jimmyfund.org/).

The database module 325 stores data related to merchandise available for purchase or auction 330, information describing the charitable organizations 335, payment history 340, and application data 345. The database server 325 also provides data to the application server 350 upon request, and updates the data as necessary. Examples of the database module 325 include the MySQL Database Server by MySQL AB of Uppsala, Sweden, the SQLServer database system of Microsoft Corporation of Redmond WA, and the ORACLE Database Server offered by ORACLE Corp. of Redwood Shores, Calif.

The merchandise database 330 contains detailed and summary information associated with the merchandise available for sale such as a description, a price, a picture, a URL, a date or time (where the merchandise is tickets to an event), the source of the merchandise, the cost to obtain the merchandise, as well as other descriptive information. In some embodiments, the merchandise database 330 may also generate and/or store unique identification codes for the merchandise, facilitating the printing of tickets with secure identification markings, codes, or other machine-readable symbols to ensure authenticity of the item.

The charity database 335 contains information about the charities 120 that are associated with the marketplace 100, and can have donations allocated to them through purchases made in the marketplace 100. Examples of information may include the name of the charity, their mission, a URL indicating their location on the World Wide Web, financial information, non-profit status, contact names, logos, pictures, documents (such as IRS filings), and the like. In some embodiments, representatives of individual charities 120 may be given access to data in the charity database 335 via the application server 350. In such cases, the representatives may query the charity database 335 to assure its accuracy, update information as it changes, or receive periodic reports detailing donations to and inquiries about their charity. In some embodiments where the user provides charities that are not already stored in the database, the system can create a record for the charity, and initiate a certification process (such as a real-time data feed, batch submission process, or other similar communication with the IRS) such that the charity will be subsequently available to receive donations.

In an embodiment the charitable organizations are maintained in a database which is searchable. An application may be executed on the database such that a list is generated by a parameter or parameters chosen in the application. A list, or several lists are generated which are more narrow in scope, and more suited to the application parameter. In use, parameters, or variables, such as the purchaser's location, as determined by zip code, and purchaser's charitable preference, are employed to generate such lists. Additional non-limiting parameters include—venue location, ticket source preference, and charitable category.

The payment database 340 contains detail and summary level data associated with purchases of merchandise 110 in the marketplace 100. Payment data may include the identity of the consumer that made a purchase, the purchase price, premium amount, tax information, administrative fees, donation allocation information, and credit card information.

Although described as relating to the selling and auctioning of merchandise such as tickets to events, travel, and other limited-supply or time-limited items, aspects of the system described above can be extended to other commercial applications. For example, the charitable donation capabilities described herein can be provided to existing or newly developed consumer or business to business commerce applications such that charitable organizations can benefit from purchases made using such systems. More specifically, in one embodiment, the allocation module 360, and the charity database 335 may be packaged as stand-alone components with standard application programming interfaces (API's) and defined data processing formats (using, for example XML, WebServices, SOAP, etc.) and integrated with existing commercial web sites.

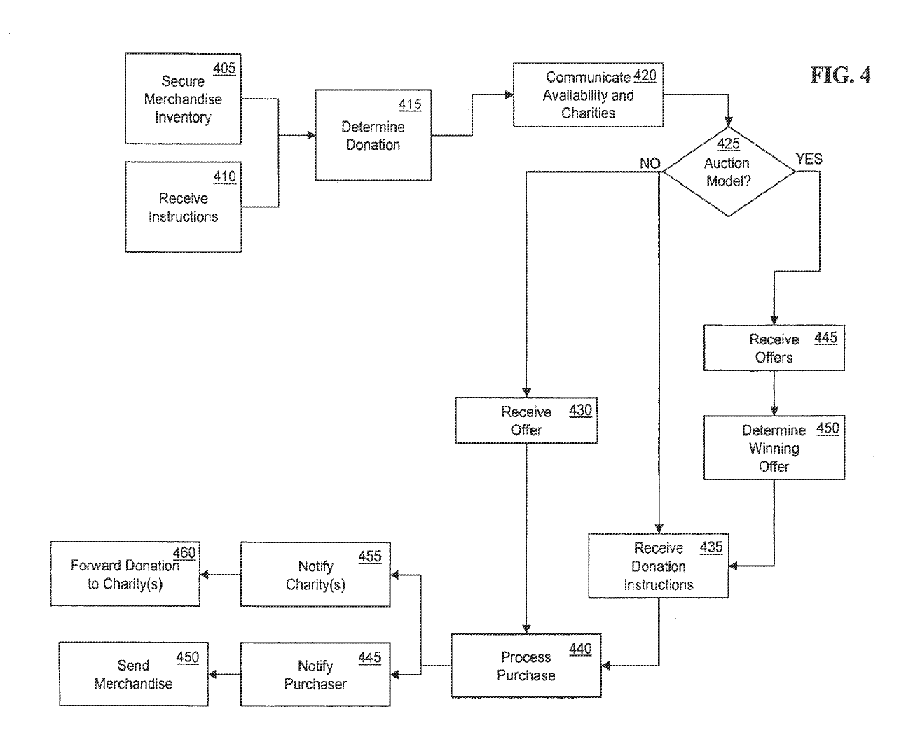

FIG. 4 illustrates one embodiment of a computerized method for allocating the proceeds of a sale of merchandise to one or more charitable organizations. Initially, administrators, operators, or other representatives of the marketplace secure merchandise (STEP 405) for sale or auction in the marketplace. The merchandise may be secured by purchasing the merchandise at a cost, receiving the merchandise as a donation, or other similar methods. In some instances where the merchandise is purchased from or donated by a third party (a “seller”) instructions can be received (STEP 410) regarding the sale of the merchandise. For example, the seller may indicate that any premium paid for the merchandise be allocated to one or more particular charities, or that the purchaser select from a group of charities. In other embodiments, the seller can indicate a particular cause of interest (e.g., cancer research, homeless shelters) and allow the purchaser to select charities that support such a cause. Other instructions may include a minimum premium amount, or specific names of charities or causes that are to be excluded from receiving a donation.

Once the merchandise is available for sale in the marketplace, the donation is determined (STEP 415). The donation can be a dollar amount, a difference between the cost and a final winning bid at auction, or a percentage of the purchase price, and may or may not take into consideration additional processing and administrative fees (e.g., credit card fees), and state and local taxes. For example, where a particular item is purchased for $100 and sold at a fixed price of $250, the donation can be $150 ($250−$100), or in some cases $125 ($250−$100−$25 delivery fee). In other cases where the item was donated and therefore received at no cost a percentage of the $250 sale price can determine the donation. In some embodiments, the percentage is very high (e.g., 98%) therefore encouraging consumers to participate in the marketplace by indicating a large share of their purchase goes to worthy causes.

Information regarding the merchandise, any specific instructions or limitations regarding its purchase, and donation information (including, in some cases, a listing of available charities to which donations can be allocated, or one specific charity that must be included in any allocation) is then communicated to the consumers (STEP 420) using, for example, the systems and methods described above. Some merchandise may be sold using an auction model or a reverse auction model, whereas other merchandise may be sold at a fixed price. A determination is made (STEP 425) as to the method of sale, and, if the merchandise is not being sold using an auction model, the marketplace awaits the receipt of an offer (STEP 430). In some embodiments, multiple offers may be received for one item. A determination of which offer to accept may be based on timing of the offers, e.g. the first offer received is accepted.

Simultaneously, or in some cases subsequent to receiving an offer to purchase the merchandise, donation instructions are also received (STEP 435) from the purchaser. In some embodiments, the donation instructions indicate that the entire premium amount be donated to one charity. In cases where the seller or administrator of the marketplace has pre-designated one or more particular charities to which the premium is to be allocation, this list is added to the donation instructions. In some embodiments, purchasers may wish that all or a portion of the premium be allocated to a charity that is not included in the list provided by the system. For example, a purchaser may be aware of a newly formed charity, or a recently organized memorial fund that is not well known, and the purchaser can “write-in” a charity previously unknown to the system. As such, the system would not recognize the charity as a viable charitable organization pursuant to IRS regulations. In such cases, the write-in charity may be added to the charity database 335, (along with information such as its name, place of business, charter, and possibly an IRS identification number) and in some cases forwarded to the IRS (in real time in some cases) via the communication modules 315 and/or 320 and the network 220 to confirm that the organization is an IRS approved charity. By allowing users to provide charities that are previously unknown to the system, smaller, lesser-known charities can benefit from the sales generated in the marketplace 100.

In some embodiments, the marketplace facilitates the allocation of the premium (or other amount available for donation) among multiple charities. In some embodiments, no allocation may be supplied, in which case the marketplace can allocate the any premium amount in equal shares among the indicated charities. In some instances the consumer may want to provide detailed allocation instructions (either in conjunction with or independent of any pre-designated charities as described above), by indicating dollar amounts and/or percentages for each of their selected charities. For example, a consumer making a purchase that includes a $100 premium may indicate that 80% of the premium be directed to a local charity that the consumer is familiar with, and the remaining 20% be donated to a national charity. By providing a custom allocation feature, consumers are given more control over the destination and amounts of their charitable donations. Using the example of tickets to sporting events or concerts, consumers will have access to limited-access tickets, without having to interact with ticket brokers or be concerned that the premiums they are paying are being channeled to individuals, companies, or causes they do not support.

If the merchandise is being sold at auction, one or more offers are received during the auction (STEP 445). The duration of the auction may be fixed to a particular time span (3 days, 24 hours, etc.), meeting a minimum bid, or in the case of tickets to an event, the date and/or time of the event (i.e., the auction ends 5 hours prior to game time). At the end of the auction, a winning offer price is determined (STEP 450) based, for example, on the amount of the bid. Generally, the highest bid will be deemed the winning bid, but other factors (valid credit card, previous bid history, etc.) may also be considered. As above, the donation instructions are received (435) either with each bid, or once a winning bid is determined.

Once an offer is received or selected (in the case of an auction sale) the purchase process (STEP 440) commences. Generally, the purchase process includes collecting payment information such as credit card information or other payment means, address/shipping information, and any promotional information, such as coupons, special offers, etc. The payment information is verified, and the sale is considered complete. The purchaser is notified (STEP 445) that they have purchased the merchandise, and, in cases where the merchandise is being held by the marketplace, the merchandise can then be sent (STEP 450) to the purchaser. The notification may include details of the purchase, such as the total amount of the purchase, the total donation amount, and detailed allocation information. By indicating the donation amount and the recipient(s) of the donation, the purchaser may use the notification as proof of their donation on, for example, an income tax return. In some embodiments, the merchandise may remain with the seller during the purchase or auction process, in which case instructions can then be sent to the seller, including the identification of the purchaser, shipping information, and donation information.

In embodiments where the merchandise includes tickets to an event, plane tickets, or cruise tickets, the tickets may be printed by the purchaser using a printer (not shown) attached to or in communication with the client 210 using bar coding or other identifiable markings. For example, if the tickets being sold are to an event in Los Angeles, and the seller has the tickets in New York, it may not be practicable to physically deliver the tickets to the purchaser in time for the event. Therefore, the system may provide an option to print a duplicate of the ticket, including a unique identification symbols (such as a bar code, serial number, or other machine-readable symbol) at the purchaser's location. Such an option eliminates the need for delivery services, and expanding the geographic area in which the merchandise can be sold. In another example, such as airline tickets, no actual ticket may exist until it is purchased, and such a printing option would be beneficial.

In some embodiments where there exist multiple instances of the same or similar merchandise, the sale can utilize a “reverse auction” model, whereby the seller (or sellers) “bid” against each other or the market, effectively lowering the sale price until a consumer determines the price is within their acceptable range. For example, if a team has five sets of tickets for a particular game, they may communicate the availability of the sets to consumers via the marketplace, and include an initial price. If no consumers express interest in the tickets at the initial price, the price may be lowered, or a higher percentage of the price may be allocated to charity.

In addition to completing the purchase process as described above, the charity(s) that were identified by the seller, the purchaser, or both are notified (STEP 455) that they are to receive donations based on the purchase, and are forwarded the appropriate funds (STEP 460). The notification can include information about the seller, the purchaser, the amount of the sale, the amount of the donation, the identities of any other charities also receiving donations based on the sale, as well as other information. In some embodiments, the purchaser may indicate that they wish their donation to remain anonymous, in which case their identity is withheld. Some purchasers may want the donations to be made on behalf of another individual or entity (e.g., a recently departed family member or an alumni group) in which case the identity(s) of such parties may also be included in the notification.

The funds can be sent before, along with, or after the notification, and in some embodiments where credit card payments are received from the purchasers, may be contingent upon receiving funds from the bank. In some instances the funds may be held by the marketplace and forwarded to the charity on a periodic (i.e., monthly) basis, and in some cases a combination of payment approaches may be used. For example, a large well-established charity may have the infrastructure to receive daily or per sale payments via an electronic funds transfer network, whereas a local charity may prefer to receive monthly payments because they rely on physically depositing paper checks.

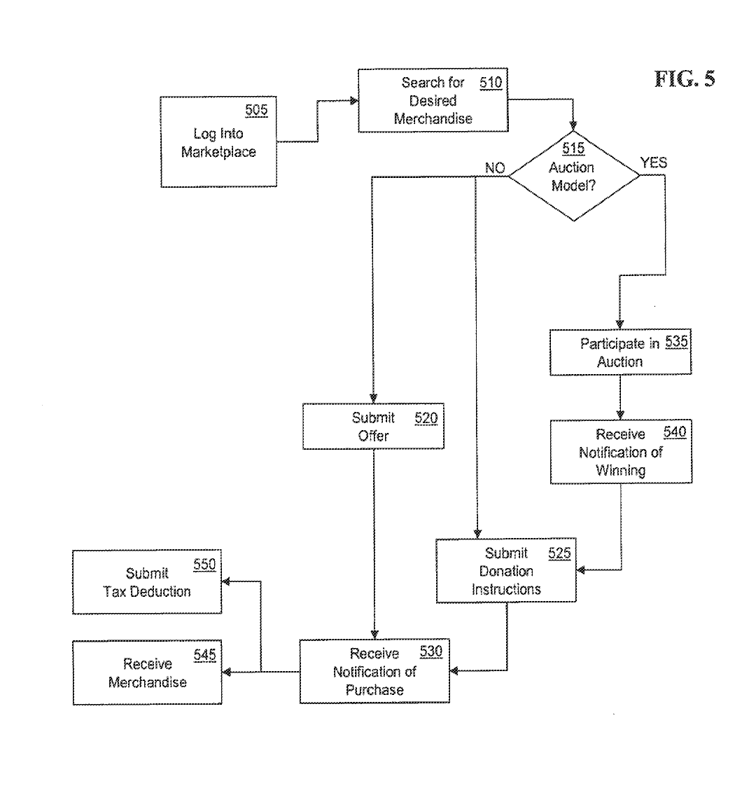

FIG. 5 illustrates an embodiment of a computerized method for making donations to charities. Using client 210 attached to network 220 and communication server 315 from FIGS. 2 and 3, for example, a consumer logs into the marketplace (STEP 505), and searches for, and/or selects (STEP 510) merchandise to purchase. As described above, some merchandise may be sold using an auction model in which case the consumer may opt not to participate, and search for similar items being sold at a fixed price (STEP 515). If the merchandise is being sold at a fixed price, the consumer submits an offer (STEP 520) and either simultaneously or subsequently submits donation instructions (STEP 525) including, for example, the names of one or more charities to which a portion of the sales proceeds will be donated. If the selected merchandise is being sold using an auction model, the consumer participates in the auction (STEP 535) by, for example, submitting one or more bids until the conclusion of the auction. If at the conclusion of the auction the consumer's bid is the winning bid, they receive a notification (STEP 540) that they were selected as the purchaser. As above, the consumer identified as the purchaser may then submit donation instructions (STEP 525) such as a charity or charities to receive a premium amount paid for the merchandise, and allocation instructions among the identified charities.

The consumer then receives notification of the purchase (STEP 530). The notification can include information about the seller, the purchaser, the amount of the sale, the amount of the donation, the identities of any other charities also receiving donations based on the sale, as well as other information. In some embodiments, the purchaser may indicate that they wish their donation to remain anonymous, in which case their identity is withheld. Some purchasers may want the donations to be made on behalf of another individual or entity (e.g., a recently departed family member or an alumni group) in which case the identity(s) of such parties may also be included in the notification. The purchaser then receives the merchandise (STEP 545), and subsequently may submit the notification (STEP 550) as evidence of a charitable donation when filing their tax return.

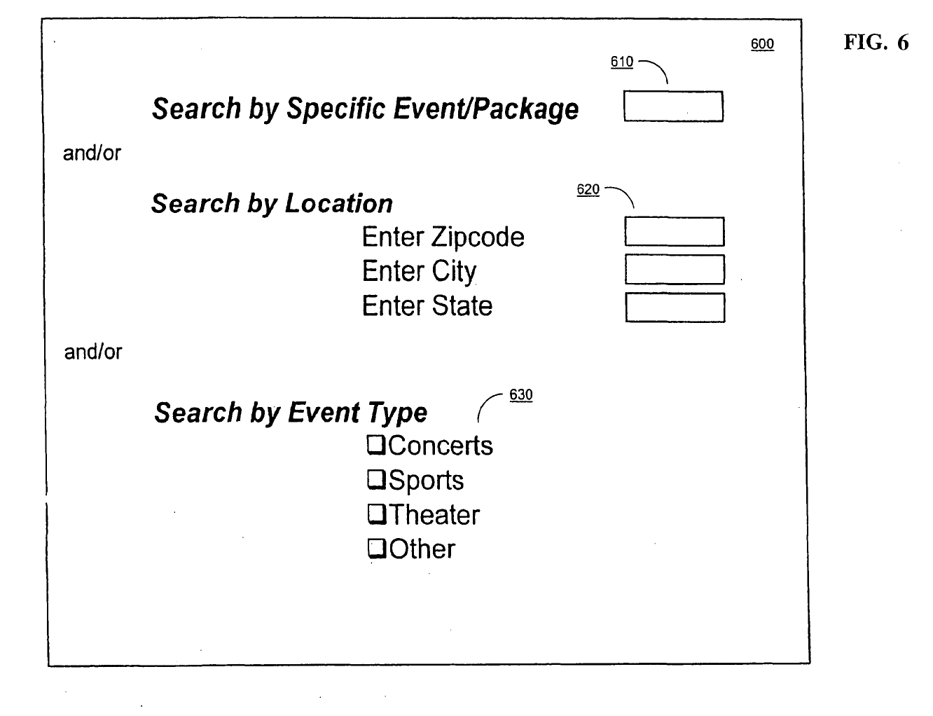

FIGS. 6 through 11 illustrate one embodiment of a system for implementing the methods and systems described above as they relate to purchasing tickets to events. Referring to FIG. 6, in one embodiment, the application server 350 provides a merchandise search screen 600 to the client 210 via the communications network 220. The merchandise search screen 600 provides a starting point where the consumer can search for and review merchandise for sale in the marketplace. Included on the screen 600 are various text fields and input fields facilitating multiple search parameters. For example, if a consumer is interested in purchasing tickets to a particular event, such as the Super Bowl, the consumer enters “Super Bowl” in event search field 610. In some instances, the event search field 610 may also be used to query the marketplace for the availability of package deals. Package deals may include tickets to an event, as well as travel arrangements such as airfare, hotels, car rental, or other complementary tickets to events related to the event of interest, such as pre-game parties, etc. Consumers may also search the marketplace by geographic region, if, for example, they are traveling to a particular destination and wish to attend an event, by using the zip code, city and/or state search fields 620. In instances where consumers are interested in a general category of events (e.g., baseball, rock concerts, etc.) the event type fields 630 can be used to query the marketplace for events in a particular category.

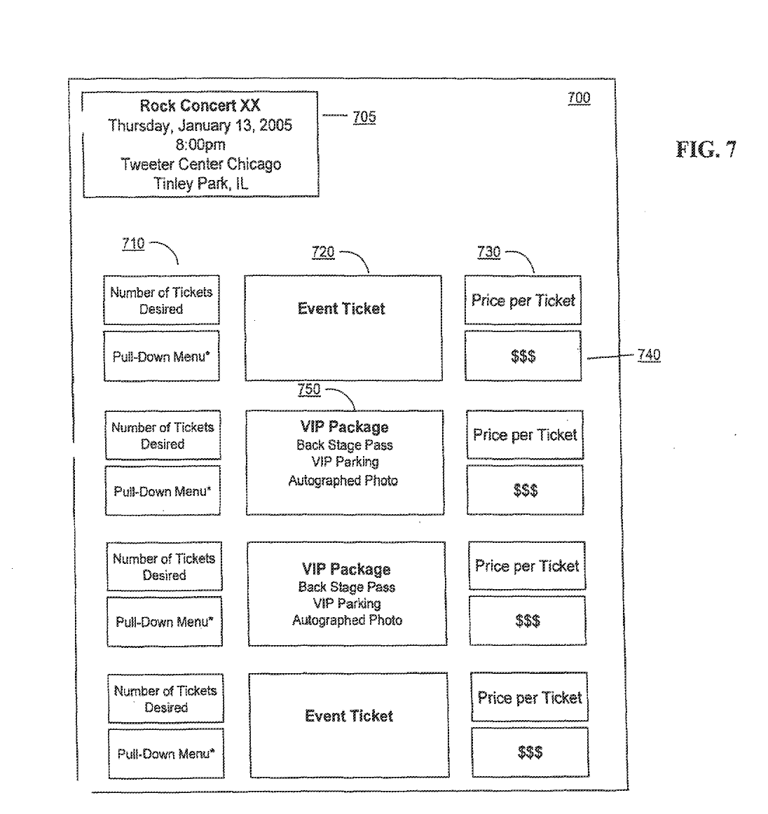

FIG. 7 illustrates one embodiment of a search results screen 700 that facilitates the review of search results based on a search for tickets to a rock concert entered on the search screen 600. The results screen 700 includes a text area 705 with descriptive information about the event such as the artist performing, the date, time, and venue. A quantity selection box 710 is provided to allow consumers to indicate the number of tickets desired. In some embodiments, entering the number of tickets may further limit or expand the availability of tickets to purchase. For example, the results screen 700 may default to a quantity of two tickets when searching for availability, however if a consumer indicates they wish to purchase 4 tickets, the list of results may be reduced if there are fewer, (or no) blocks of four tickets available for that particular event. Similarly, a request for one ticket may expand the list if single tickets are available in the marketplace. The results screen 700 also includes a description 720 of the event, which in some cases may be displayed with an image (in the form of a GIF, TIF, or JPEG file for example) of the ticket, the artist, the venue, or other pictorially descriptive image. A price per ticket field 730 displays the per ticket cost for the event. In some embodiments, the price per ticket field 730 displays the cost of the ticket plus any premium amount added to the tickets that will become the charitable donation. In other cases, the cost per ticket field 730 may include taxes, administrative fees, delivery fees, or combinations thereof. If the tickets are being sold using an auction model, the price per ticket field 730 can indicate a minimum bid, or, if the auction is in progress, the current high bid. A total cost field 740 indicates the cost of purchasing the tickets by multiplying the number of tickets indicated in the quantity selection box 710 by the amount indicated in the cost per ticket field 730. Administrative fees, delivery fees, taxes, and other transactional fees may, in some embodiments where omitted from the cost per ticket field 730, may be included in the total cost field 740. For some events, the marketplace may include various special packages such as “VIP Packages” that can include additional merchandise, back stage access, parking, or other services in addition to the event tickets, as well as life-experience type merchandise such as meeting celebrities and/or political and business figures, attending one time events (a Presidential inauguration). In some embodiments, the results screen 700 lists both the standard ticket package 720, as well as VIP packages 750, typically, although not necessarily, at a higher price.

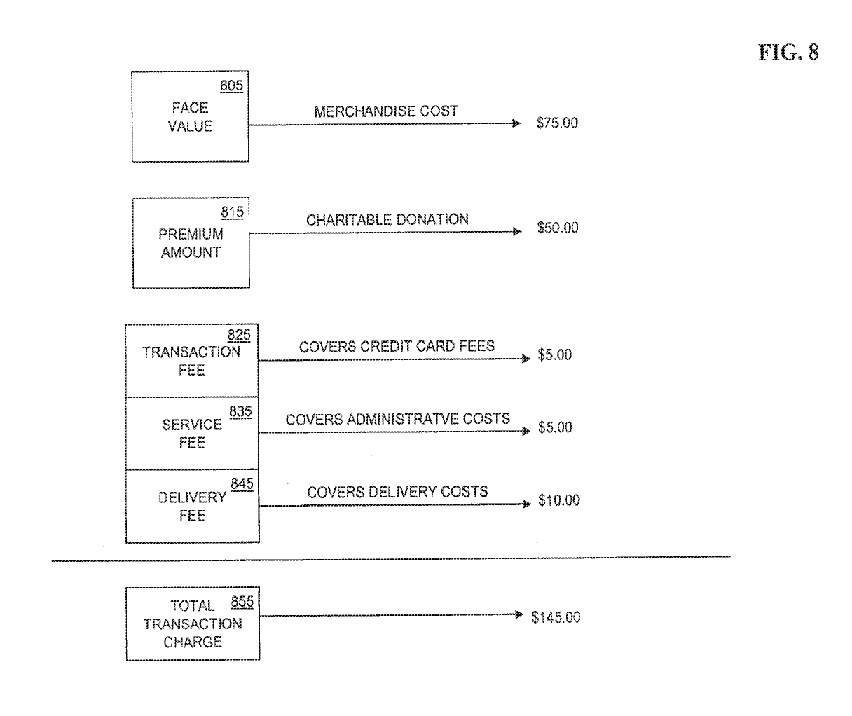

FIG. 8 illustrates one possible embodiment of the price calculation method. If, for example, the merchandise being sold in the marketplace was obtained at a $75.00 “face value” (e.g., not donated, but purchased for the price printed on the face of the ticket) the merchandise cost is set to $75. The marketplace then determines, based either on input from the seller, or independently, a premium 815 that is to be collected for the tickets, in this case $50. In some cases, the premium may be $0, and an auction model is used to determine the premium. In embodiments where the method of payment is credit card, a transaction fee 825 (in this case $5) may be added to cover the fees associated with use and settlement of the credit card charge. A service fee 835 (again, in this example $5) may also be added to cover the costs of operating and administering the marketplace, advertising fees, and the like. Where the merchandise is to be delivered, a delivery fee 845 ($10) can defray delivery costs. In some cases where the merchandise has a “face value,” such amounts may not be tax deductible, and therefore kept to further fund the operations of the system, or purchase additional merchandise.

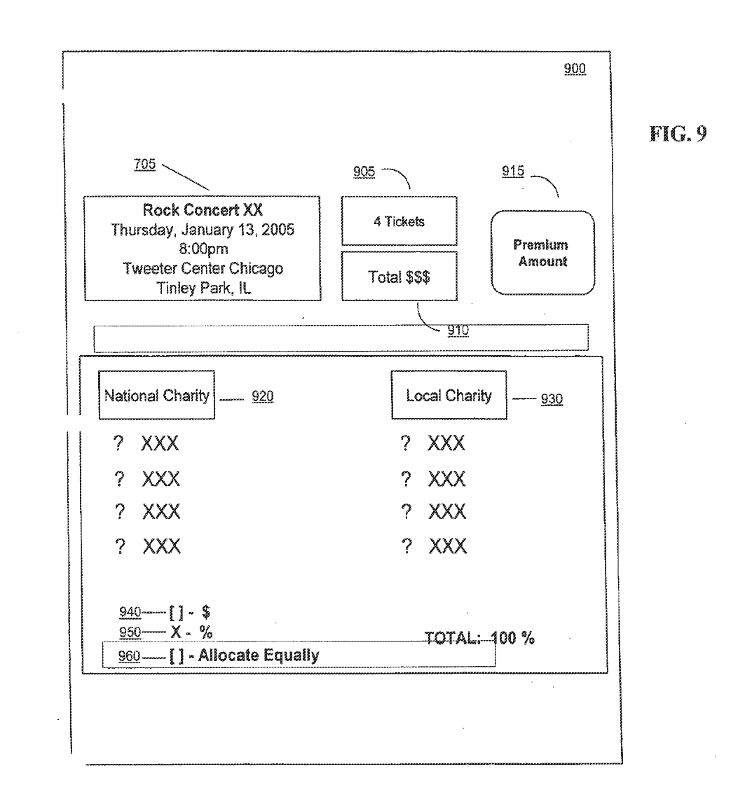

Referring to FIG. 9, a donation allocation screen 900 facilitates the allocation of a premium paid for the merchandise to one or more charities. The allocation screen 900 includes the descriptive text 705 describing the event, the number of tickets 905 selected, the total price 910, and based on the cost of the tickets (either face value, $0 if donated to the marketplace, or a cost paid to a seller) the premium amount 915 paid for the merchandise. The donation allocation screen 900 can include one or more listings of charitable organizations to which the premium 915 can be donated, and in some embodiments the listing includes a list of national charities 920 and a list of local charities 930. In some cases, the donation allocation screen 900 may present the user with one or more pre-designated charitable organizations to which donations will be made, and allow the user to add additional charities to the list. The list of local charities can be determined based on the demographic information of the consumer, the geographic area in which the event is taking place, or based on a list provided by the consumer. In some cases, one or more blank text boxes are provided to facilitate entering of the identity of a charity that is not on the initial lists, 920 and 930.

The donation allocation screen 900 further allows the consumer to determine the method of allocation among selected charities. A per dollar method check box 940 indicates to the marketplace that the consumer wishes to enter dollar amounts for each of their selected charities. For example, if the premium amount paid is $100 the consumer can select the per dollar method check box 940, and enter dollar amounts such as $35, $50, and $15 adjacent to three of the charities, thus adding up to the $100 premium. In some embodiments, where the sum of the dollar amounts entered is greater than the premium, the consumer is queried if they wish to increase the premium, thus allowing a greater donation than originally elected. A percentage method check box 950 indicates to the marketplace that the consumer intends to allocate the premium based on percentages, (e.g., 25%, 25% and 50%) such that the indicated percentages add up to 100%. An equal allocation check box 960 allows the consumer to instruct the marketplace to allocate the premium amount equally among the indicated charities. For example, if the consumer indicates that the premium amount is to be allocated equally among 5 charities, 20% of the premium will be allocated to each charity. In some embodiments where a pre-specified charity is selected by the seller of the merchandise and/or the administrator of the system, the amount allocated to the pre-specified charity can be fixed (e.g., 25%, $100, etc.) and the remainder of the premium allocated to the additional charities identified by the purchaser.

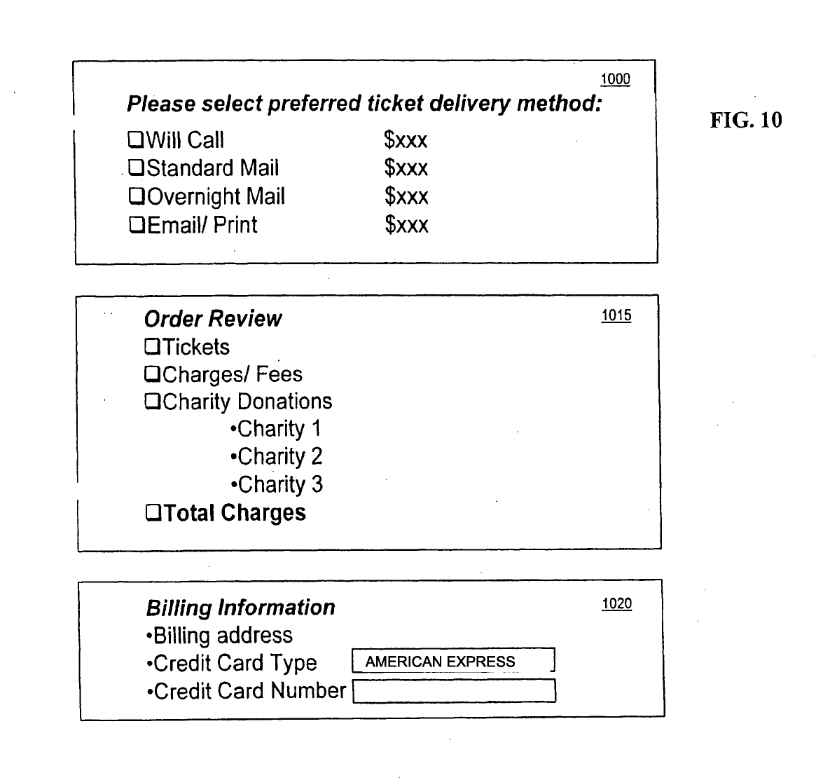

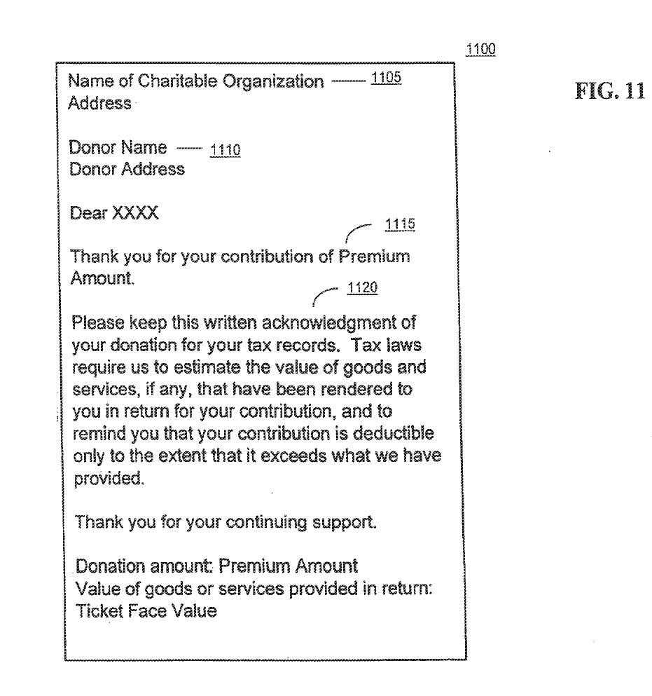

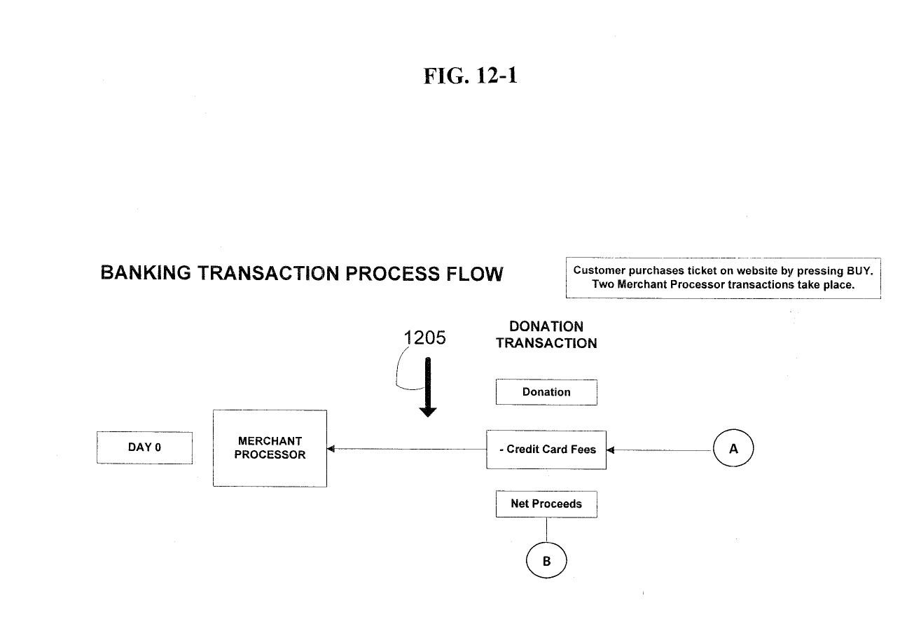

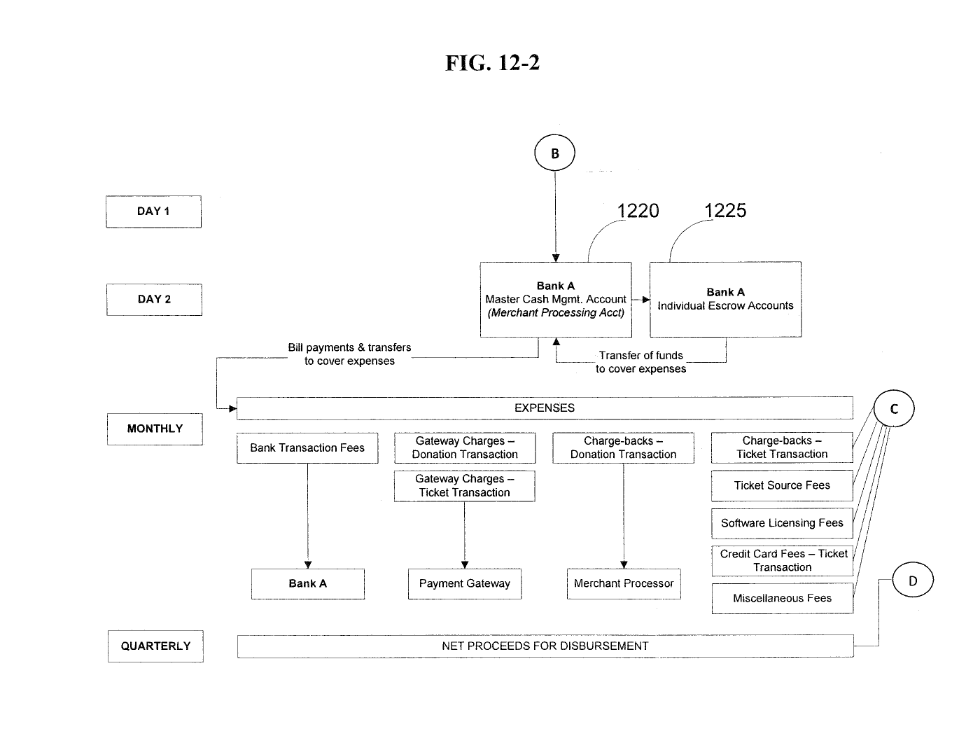

Referring to FIG. 10, a delivery method screen 1000, an order review screen 1015, and a billing information screen 1020 are provided to complete the purchase transaction. In some embodiments, each of these three screens 1000, 1015, and 1020 are provided on separate HTML pages, whereas in other embodiments, the information and functionality provided be each screen can be provided in any order or combination. The delivery method screen 1000 allows the consumer to select a preferred method of deliver of the merchandise purchased. In some cases where the merchandise is tickets to an event and the event is imminent, some options (such as US Mail) may be deactivated because the tickets would not arrive in time. In some embodiments where electronic ticketing and optical character recognition is employed on tickets, the consumer can print replacement tickets using the client 210 and a standard printer. In some cases, electronic versions (PDF, HTML, TIF, or other electronic rendering format) of the tickets may be saved on a hand-held device and presented for entry to the event.

The order review screen 1015 provides a summary of the merchandise purchased, the total charges, including fees, taxes, deliver charges, etc. and the various charitable donations and the organizations to which they are being allocated. The billing information screen 1020 allows the consumer to select a method of payment, and provide necessary account and/or address information to process the payment.

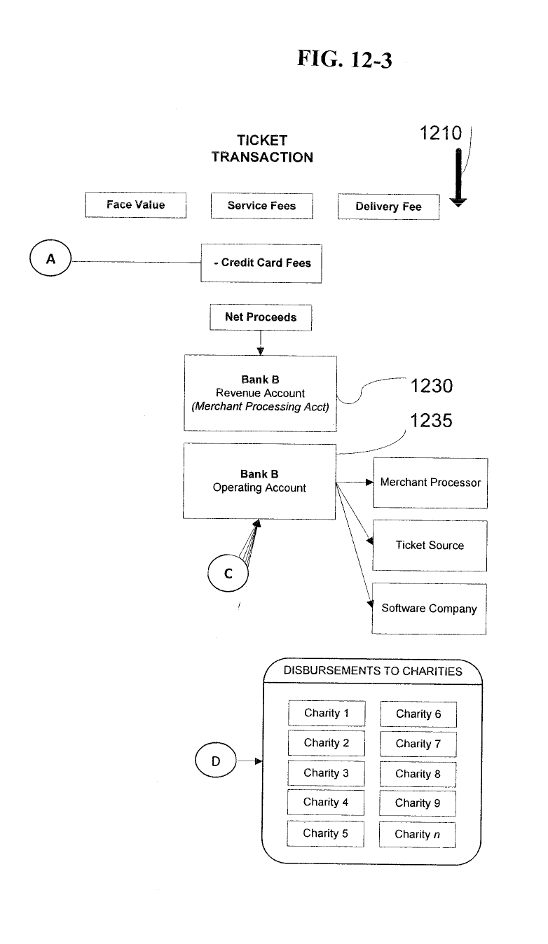

Referring to FIG. 11, a sample donation confirmation letter 1100 provides a written receipt of the consumers purchase, and evidence of their charitable donation. The example letter 1100 can include, for example, the name 1110 of the consumer (listed as the donor of the charitable contributions), an acknowledgement 1115 of the amount over cost paid for the merchandise, and instructions 1120 regarding the treatment of the receipt for tax purposes. In some embodiments, the receipt includes the specific amounts allocated to each charity, and the names of the charities. In some cases, separate letters 1100 may be provided for each donation. For example, were a consumer allocates the premium amount to three charities, three separate letters may be provided. The letter 1100 can subsequently be used as an indication of charitable donation(s) and included, for example, with a tax return.

In an embodiment, the method provides an inventory source logic with the ability to uniquely identify and tag individual tickets by source of inventory to differentially: 1) serve and populate a list of potential charities from which the purchaser may choose to donate; 2) allocate percentages of the donation amount to the same list of charities; and/or 3) serve and populate the list and create unique rules for allocation among the list of charities.

In an embodiment, it further provides the ability to associate individual tickets with a specific ticket source and/or a specific charitable organization. In practice, this means that some Team A tickets can be used to raise money for Charitable Organization A while other Team A tickets can be used to raise money for Charitable Organization B. Also, we may get Team A tickets from Source A and some Team A tickets from Source B. We can link Source A's Team A tickets with a different charitable organization(s) from Source B's Team A tickets. For example, some Celtics tickets can be used to raise money for United Way of America while other Celtics tickets can be used to raise money for the Shamrock Foundation—at any rate from 0% to 100%. Also, we may get some Celtics tickets from a Season Ticket Holder and some Celtics tickets from the team directly (or some third-party source such as the players, corporate sponsors, etc.). We can link a Season Ticket Holder's Celtics tickets to a different charitable organization(s) from the teams own Celtics tickets.

Further, it is possible to predetermine that for a specific ticket, X% goes to Charitable Organization A based on some third-party preference (e.g. the team, corporate sponsor) and permitting the customer to select one or more charitable organizations to receive an equal (or otherwise split) allocation of the remainder of the premium. For example, for all Red Sox tickets, 20% of the premium would be automatically allocated to the Red Sox Foundation (based on the preference of the Red Sox as a ticket source). The remaining 80% of the premium could be allocated to charities selected by the purchaser from our predetermined list.

Referring to FIG. 12, a purchase transaction of a ticket is shown (although it may be any merchandise or service), which bifurcates into two transactions, a donation transaction 1205 and a ticket transaction 1210. A credit card fee is removed from a donation to yield a net proceed, which is initially deposited in a merchant processing account. The donation is then transferred to a master cash management account 1220. Some money is used from account 1220 for bill payment to cover expenses, such as transaction fees, verisign charges, and charge-back transactions. Some proceeds from account 1220 are transferred to individual escrow account 1225, from which quarterly disbursements are made to a designated charitable organization.

Referring to a ticket transaction 1210, fees such as cost, service, and delivery fees may be initially removed from the total amount. Credit card fees are also removed to yield a net proceed, which is deposited in a revenue account 1230. An operating account 1235 is also maintained, and is in communication with all accounts, and serves as a general account through which a business may operate the charitable giving method described herein.

Variations, modifications, and other implementations of what is described herein will occur to those of ordinary skill in the art without departing from the spirit and the scope of the invention. The invention is not to be defined by the preceding illustrative description.

What is claimed is:

1-53. (canceled)

54. A method of obtaining donations to a charitable organization by selling a product, the method comprising:
associating, in a database, a plurality of parameter values with each item of the product for sale, wherein each parameter value is assigned specifically to each item of product, and wherein one of the parameters is a product purchase price and another parameter is a required donation amount;
offering, by a computer, the item of product for the product price and the required donation amount, the product price and donation amount being set in response to the parameter values assigned specifically to the item of product;
communicating, by computer, information about the item of product to a purchaser, and
receiving from the purchaser an offer of payment to purchase the item of product and the payment of the donation amount.

55. The method of claim 54 further comprising the step of the purchaser identifying the charitable organization to which said donation amount is to be allocated.

56. The method of claim 54 wherein the purchase price includes one or more fees, the one or more fees comprising a delivery fee, an administrative fee, a ticket source fee, and a processing fee.

57. The method of claim 54 wherein the item of merchandise is one or more tickets to an event.

58. The method of claim 57 wherein said one or more tickets are confirmed to be authentic prior to said communicating information about the item of merchandise.

59. The method of claim 54 further comprising qualifying said one or more charitable organizations prior to communicating the identities of the one or more charitable organizations to the purchaser.

60. The method of claim 59 wherein the qualification comprises determining that each of the charitable organizations is recognized as a charitable organization by the Internal Revenue Service.

61. The method of claim 54 further comprising receiving, from the purchaser, payment for the item of merchandise.

62. The method of claim 55 further comprising sending the donation amount to said one or more charitable organizations.

63. The method of claim 55 wherein said purchaser further identifies a percentage allocation to said one or more charitable organizations.
